(19) United States
(12) Patent Application Publication
(10) Pub. No.: US 2017/0110113 A1
(43) Pub. Date: Apr. 20, 2017

(54) ELECTRONIC DEVICE AND METHOD FOR TRANSFORMING TEXT TO SPEECH UTILIZING SUPER-CLUSTERED COMMON ACOUSTIC DATA SET FOR MULTI-LINGUAL/SPEAKER

(71) Applicant: Samsung Electronics Co., Ltd., Suwon-si (KR)

(72) Inventors: Junesig SUNG, Yongin-si (KR); Gunu JHO, Hwaseong-si (KR); Jaecheol BAE, Suwon-si (KR); Gwanghoon KIM, Hwaseong-si (KR); Hana KO, Suwon-si (KR); Sora BAE, Suwon-si (KR); Eunzu YUN, Suwon-si (KR); Hongil CHO, Suwon-si (KR)

(21) Appl. No.: 15/293,879

(22) Filed: Oct. 14, 2016

(30) Foreign Application Priority Data
Oct. 16, 2015 (KR) 10-2015-0144462

(51) Int. Cl. G10L 13/08; G10L 13/04; G10L 13/033

(52) U.S. Cl. CPC G10L 13/086; G10L 13/0335; G10L 13/04

(57) ABSTRACT

An electronic device is provided. The electronic device includes a processor and a memory electrically connected to the processor. The memory stores a super-clustered common acoustic data set and instructions to allow the processor to acquire at least one text, select information associated with a speech into which the acquired text is transformed, when the selected information is first information, select at least one of first paths, load elements of the super-clustered common acoustic data set based on the selected first paths, and generate a first acoustic signal based on the elements of the super-clustered common acoustic data set, and when the selected information is second information, select at least one of second paths, load elements of the super-clustered common acoustic data set based on the at least one second path, and generate a second acoustic signal based on the elements of the super-clustered common acoustic data set.

### CROSS-REFERENCE TO RELATED APPLICATION(S)

This application claims the benefit under 35 U.S.C. §119(a) of a Korean patent application filed on Oct. 16, 2015 in the Korean Intellectual Property Office and assigned Serial number 10-2015-0144462, the entire disclosure of which is hereby incorporated by reference.

### TECHNICAL FIELD

The present disclosure relates to an electronic device performing a parameter based text to speech (TTS). More particularly, the present disclosure relates to an electronic device performing a TTS transformation using a super-clustered common acoustic data set supporting multi-lingual/speaker utilizing the super-clustered common acoustic data set and a method for transforming TTS thereof.

### BACKGROUND

A parameter based text to speech (TTS) transformation may have a language processor and speech data for each language and select appropriate speech data based on a sentence analysis result of an input sentence and generate a synthesized sound based on a connection and a transformation thereof. Since the TTS transformation does not receive a speech as an input like a coder-decoder (CODEC) and receives a text as an input, a process of estimating speech data suited for a text and storing the estimated speech data as a form of an acoustic model may be performed first of all. The parameter based TTS may have acoustic models for each language and speaker and each of the acoustic models may have a size of about 5 MB.

In the case of providing commercial service of the TTS for multi-lingual, as the number of service languages and the number of support speakers by language are increased, the speech data of the acoustic model for a kind of languages or a kind of speakers are increased accordingly, and therefore there may be the problem in that a capacity burden of an electronic device is increased. Further, a decision-tree based acoustic model may mass-produce a leaf node representing acoustic data in a subdivided phoneme unit in which a phoneme unit is divided and an acoustic signal in the subdivided phoneme unit is not easily distinguished with humans' ears. The phenomenon that the leaf node having a similar form is mass-produced may conspicuously appear between a heterogeneous language and a speaker, which may cause the problem in that the acoustic model itself that is divided and stored by language and speaker includes high redundancy.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for transforming text to speech (TTS) that may configure super-clustered common acoustic data (SCCAD) shared by multi-lingual/speaker and have greatly reduced capacity by performing a parameter based TTS transformation based on the super-clustered common acoustic data supporting the multi-lingual/speaker.

In accordance with an aspect of the present disclosure, an electronic device is provided. The electronic device includes a processor and a memory electrically connected to the processor, in which the memory is configured to store a super-clustered common acoustic data set and wherein the memory is further configured to store instructions to allow the processor to acquire at least one text, select information associated with a speech into which the acquired text is transformed, when the selected information is first information, select at least one of a plurality of first paths, load at least one element of the super-clustered common acoustic data set based on the selected at least one first path, and generate a first acoustic signal based on the loaded at least one element of super-clustered common acoustic data set, and when the selected information is second information, select at least one of the plurality of second paths, load at least one or at least one other element of the super-clustered common acoustic data set based on the selected at least one second path, and generate a second acoustic signal based on the loaded at least one or at least one other element super-clustered common acoustic data set.

In accordance with another aspect of the present disclosure, an electronic device is provided. The electronic device includes a processor, and a memory electrically connected to the processor, wherein the memory is configured to store instructions to allow the processor to: acquire a first acoustic data set corresponding to the first information associated with the speech and a second acoustic data set corresponding to the second information associated with the speech, determine a similarity between at least one element of the first acoustic data set and/or at least one element of the second acoustic data set, and generate a super-clustered common acoustic data set associated with the at least one element of the first acoustic data set and/or the at least one element of the second acoustic data set based on the determination.

In accordance with another aspect of the present invention, a method of transforming TTS of an electronic device is provided. The method includes acquiring at least one text, selecting information associated with a speech into which the acquired text is transformed, when the selected information is first information, selecting at least one of a plurality of first paths, loading at least one element of the super-clustered common acoustic data set based on the selected at least one first path, and generating a first acoustic signal based on the loaded at least one element of the super-clustered common acoustic data set, when the selected information is first information, and when the selected information is second information, selecting at least one of the plurality of second paths, loading at least one element or at least one other element of the super-clustered common acoustic data set based on the selected at least one second path, and generating a second acoustic signal based on the loaded at least one element or at least one other element of super-clustered common acoustic data set.

In accordance with another aspect of the present invention, a method for transforming TTS of an electronic device is provided. The method includes acquiring a first acoustic data set corresponding to first information associated with a speech into which at least one text is transformed and/or a second acoustic data set corresponding to second information associated with the speech, determining a similarity between at least one element of the first acoustic data set and/or at least some one element of the second acoustic data set, and generating a super-clustered common acoustic data set associated with the at least one element of the first acoustic data set and/or the at least one element of the second acoustic data set based on the determination.

According to various embodiments of the present disclosure, the electronic device may perform the TTS transformation based on one super-clustered common acoustic data set supporting the multi-lingual/speaker, thereby reducing the storage space required to store the plurality of acoustic data sets.

According to various embodiments of the present disclosure, the electronic device downloads only the linker of the additional acoustic model for the already generated super-clustered common acoustic data set when an acoustic model for a new language or speaker is additionally installed in the electronic device, thereby reducing the burden of the electronic device required for the data transmission.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network environment including an electronic device according to an embodiment of the present disclosure;

FIG. 2 is a block diagram of the electronic device according to various embodiments of the present disclosure;

FIG. 3 is a block diagram of a program module according to various embodiments of the present disclosure;

FIG. 4 is a flow chart illustrating an operation of the electronic device that selects information associated with a speech into which a text will be transformed and generates an acoustic signal based on the selected information according to various embodiments of the present disclosure;

FIG. 5 is a diagram illustrating an operation of the electronic device that maps at least one path of an acoustic data set to at least a part of a super-clustered common acoustic data set according to various embodiments of the present disclosure;

FIG. 6 is a flow chart illustrating an operation of the electronic device that generates super-clustered common acoustic data according to various embodiments of the present disclosure;

FIG. 7A is a diagram illustrating an operation of the electronic device that determines similarity between at least a part of a first acoustic data set and at least a part of a second acoustic data set and generates the super-clustered common acoustic data set based on the determination on the similarity according to various embodiments of the present disclosure;

FIG. 7B is a diagram illustrating an operation of the electronic device that performs a clustering algorithm in the entire acoustic data set collecting at least one acoustic data set according to various embodiments of the present disclosure;

FIG. 8 is a diagram illustrating an operation of the electronic device that generates the super-clustered common acoustic data set and matches a plurality of paths of a specific acoustic data to the super-clustered common acoustic data set according to various embodiments of the present disclosure; and

FIG. 9 is a block diagram of a first electronic device and a block diagram of a second electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a portable medical device, a digital camera, or a wearable device (e.g., an head-mounted device (HMD) such as electronic glasses, electronic clothes, an electronic bracelet, an electronic necklace, an electronic appcessory, an electronic tattoo, a smart mirror, or a smart watch).

According to some embodiments, an electronic device may be a smart home appliance that involves a communication function. For example, an electronic device may be a television (TV), a digital versatile disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.)

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

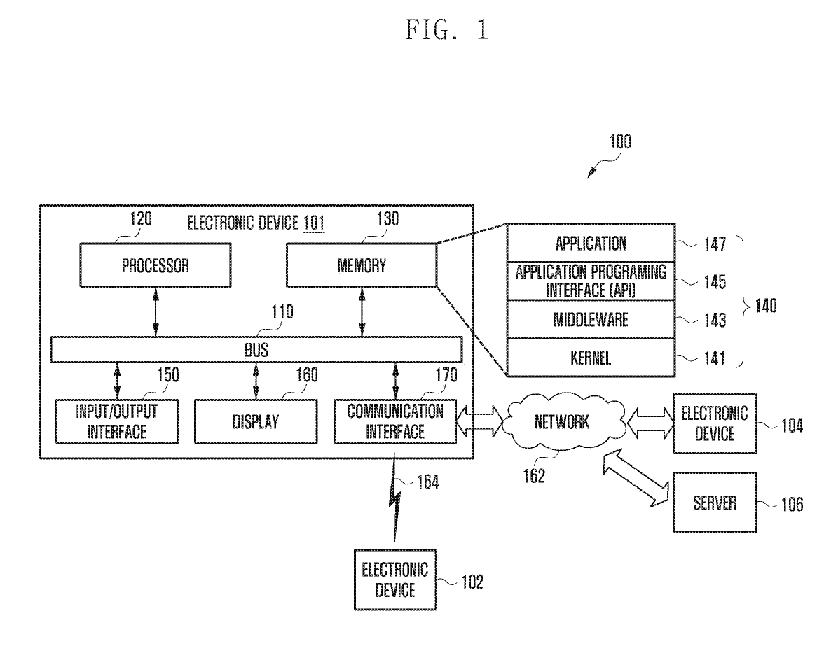

FIG. 1 illustrates a network environment including an electronic device according to various embodiments of the present disclosure.

Referring to FIG. 1, an electronic device 101, in a network environment 100, includes a bus 110, a processor 120, a memory 130, an input/output interface 150, a display 160, and a communication interface 170. According to some embodiments, the electronic device 101 may omit at least one of the components or further include another component.

The bus 110 may be a circuit connecting the above described components and transmitting communication (e.g., a control message) between the above described components.

The processor 120 may include one or more of CPU, AP or communication processor (CP). For example, the processor 120 may control at least one component of the electronic device 101 and/or execute calculation relating to communication or data processing.

The memory 130 may include volatile and/or non-volatile memory. For example, the memory 130 may store command or data relating to at least one component of the electronic device 101. According to some embodiment, the memory may store software and/or program 140. For example, the program 140 may include a kernel 141, middleware 143, an application programming interface (API) 145, and/or an application 147 and so on. At least one portion of the kernel 141, the middleware 143 and the API 145 may be defined as operating system (OS).

The kernel 141 controls or manages system resources (e.g., the bus 110, the processor 120, or the memory 130) used for executing an operation or function implemented by the remaining other program, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 may be used, to the application 147.

The API 145 is an interface by which the application 147 may control a function provided by the kernel 141 or the middleware 142 and includes, for example, at least one interface or function (e.g., command) for a file control, a window control, image processing, or a character control.

The input/output interface 150 may be interface to transmit command or data inputted by a user or another external device to another component(s) of the electronic device 101. Further, the input/output interface 150 may output the command or data received from the another component(s) of the electronic device 101 to the user or the other external device.

The display 160 may include, for example, liquid crystal display (LCD), light emitting diode (LED), organic LED (OLED), or micro electro mechanical system (MEMS) display, or electronic paper display. The display 160 may display, for example, various contents (text, image, video, icon, or symbol, and so on) to a user. The display 160 may include a touch screen, and receive touch, gesture, approaching, or hovering input using a part of body of the user.

The communication interface 170 may set communication of the electronic device 101 and external device (e.g., a first external device 102, a second external device 104, or a server 106). For example, the communication interface 170 may be connected with the network 162 through wireless communication or wire communication and communicate with the external device (e.g., a second external device 104 or server 106).

Wireless communication may use, as cellular communication protocol, at least one of long-term evolution (LTE), LTE advance (LTE-A), code division multiple access (CDMA), wideband CDMA (WCDMA), universal mobile telecommunications system (UMTS), wireless broadband (WiBro), global system for mobile communications (GSM), and the like, for example. A short-range communication 164 may include, for example, at least one of Wi-Fi, Bluetooth (BT), near field communication (NFC), magnetic secure transmission or near field magnetic data stripe transmission (MST), and global navigation satellite system (GNSS), and the like.

An MST module is capable of generating pulses corresponding to transmission data using electromagnetic signals, so that the pulses can generate magnetic field signals. The electronic device 101 transmits the magnetic field signals to a POS terminal (reader). The POS terminal (reader) detects the magnetic field signal via an MST reader, transforms the detected magnetic field signal into an electrical signal, and thus restores the data.

The GNSS may include at least one of, for example, a GPS, a global navigation satellite system (GLONASS), a BeiDou navigation satellite system (hereinafter, referred to as “BeiDou”), and Galileo (European global satellite-based navigation system). Hereinafter, the “GPS” may be interchangeably used with the “GNSS” in the present disclosure. Wired communication may include, for example, at least one of universal serial bus (USB), high definition multimedia interface (HDMI), recommended standard-232 (RS-232), plain old telephone service (POTS), and the like. The network 162 may include telecommunication network, for example, at least one of a computer network (e.g., local area network (LAN) or wireless area network (WAN)), internet, and a telephone network.

Each of the first external device 102 and the second external device 104 may be same type or different type of device with the electronic device 101. According to some embodiment, the server 106 may include one or more group of servers. According to various embodiments, at least one portion of executions executed by the electronic device may be performed by one or more electronic devices (e.g., external electronic device 102, 104, or server 106). According to some embodiments, when the electronic device 101 should perform a function or service automatically, the electronic device 101 may request performing of at least one function to the other device (e.g., external electronic device 102, 104, or server 106). For the above, cloud computing technology, distributed computing technology, or client-server computing technology may be used, for example.

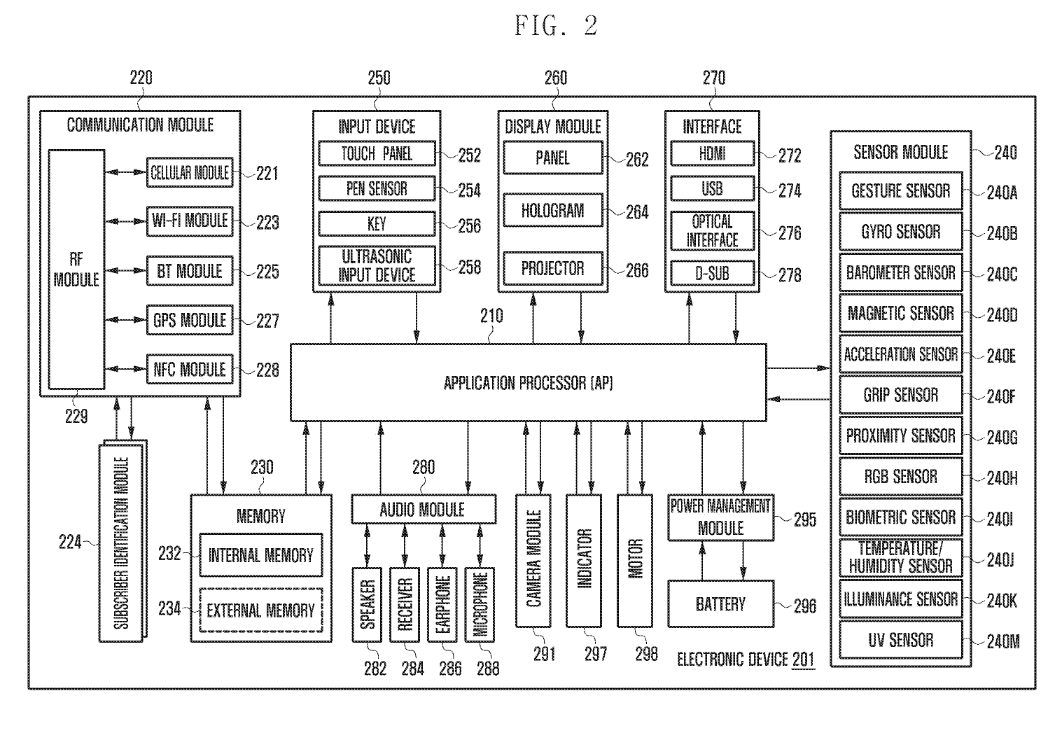

FIG. 2 illustrates a block diagram of an electronic device according to an embodiment of the present disclosure.

Referring to FIG. 2, an electronic device 201 may configure, for example, a whole or a part of the electronic device 101 illustrated in FIG. 1. The electronic device 201 includes one or more APs 210, a communication module 220, a subscriber identification module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an OS or an application program so as to control a plurality of hardware or software component elements connected to the AP 210 and execute various data processing and calculations including multimedia data. The AP 210 may be implemented by, for example, a system on chip (SoC). According to an embodiment, the processor 210 may further include a graphics processing unit (GPU) and/or image signal processor. The AP 210 may include at least one portion of components illustrated in FIG. 2 (e.g., a cellular module 221). The AP 210 may load command or data received from at least one of another component (e.g., non-volatile memory), store various data in the non-volatile memory.

The communication module 220 may include same or similar components with the communication interface 170 of FIG. 1. The communication module 220, for, example, may include the cellular module 221, a Wi-Fi module 223, a BT module 225, a GPS module 227, a NFC module 228, and a radio frequency (RF) module 229.

The cellular module 221 provides a voice, a call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using a SIM (e.g., the SIM card 224). According to an embodiment, the cellular module 221 performs at least some of the functions which may be provided by the AP 210. For example, the cellular module 221 may perform at least some of the multimedia control functions. According to an embodiment, the cellular module 221 may include a CP.

Each of the Wi-Fi module 223, the BT module 225, the GPS module 227, and the NFC module 228 may include, for example, a processor for processing data transmitted/received through the corresponding module. Although the cellular module 221, the Wi-Fi module 223, the BT module 225, the GPS module 227, and the NFC module 228 are separate modules, at least some (e.g., two or more) of the cellular module 221, the Wi-Fi module 223, the BT module 225, the GPS module 227, and the NFC module 228 may be included in one integrated chip (IC) or one IC package according to one embodiment. For example, at least some (e.g., the CP corresponding to the cellular module 221 and the Wi-Fi processor corresponding to the Wi-Fi module 223 of the processors corresponding to the cellular module 221, the Wi-Fi module 223, the BT module 225, the GPS module 227, and the NFC module 228 may be implemented by one SoC.

The RF module 229 transmits/receives data, for example, an RF signal. Although not illustrated, the RF module 229 may include, for example, a transceiver, a power amp module (PAM), a frequency filter, a low noise amplifier (LNA) and the like. Further, the RF module 229 may further include a component for transmitting/receiving electronic waves over a free air space in wireless communication, for example, a conductor, a conducting wire, and the like. Although the cellular module 221, the Wi-Fi module 223, the BT module 225, the GPS module 227, and the NFC module 228 share one RF module 229 in FIG. 2, at least one of the cellular module 221, the Wi-Fi module 223, the BT module 225, the GPS module 227, and the NFC module 228 may transmit/receive an RF signal through a separate RF module according to one embodiment.

The SIM card 224 is a card including a SIM and may be inserted into a slot formed in a particular portion of the electronic device. The SIM card 224 includes unique identification information (e.g., IC card identifier (ICCID)) or subscriber information (e.g., international mobile subscriber identity (IMSI).

The memory 230 (e.g., memory 130) may include an internal memory 232 or an external memory 234. The internal memory 232 may include, for example, at least one of a volatile memory (e.g., a random access memory (RAM), a dynamic RAM (DRAM), a static RAM (SRAM), a synchronous dynamic RAM (SDRAM), and the like), and a non-volatile memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, and the like).

According to an embodiment, the internal memory 232 may be a solid state drive (SSD). The external memory 234 may further include a flash drive, for example, a compact flash (CF), a secure digital (SD), a micro-SD, a mini-SD, an extreme digital (xD), or a memory stick. The external memory 234 may be functionally connected to the electronic device 201 through various interfaces. According to an embodiment, the electronic device 201 may further include a storage device (or storage medium) such as a hard drive.

Upon performance, the memory 230 according to various embodiments of the present disclosure may store instructions to allow the processor 210 to acquire at least one text, select information associated with a speech into which the acquired text will be transformed, when the selected information is first information, select at least one of a plurality of first paths, load some of the super-clustered common acoustic data set based on the selected at least one first path, and generate a first acoustic signal based on the loaded some super-clustered common acoustic data set, and when the selected information is second information, select at least one of the plurality of second paths, load some or another some of the super-clustered common acoustic data set based on the selected at least one second path, and generate a second acoustic signal based on the loaded some or another some super-clustered common acoustic data set.

Upon performance, the memory 230 according to various embodiments of the present disclosure may store instructions to allow the processor 210 to acquire the at least one text from a user or receive a text message including the at least one text from an external device.

Upon performance, the memory 230 according to various embodiments of the present disclosure may store instructions to allow the processor 210 to select at least some of some of the super-clustered common acoustic data set based on the input text and generate the first acoustic signal or the second acoustic signal additionally based on at least some of some of the super-clustered common acoustic data set.

Upon performance, the memory 230 according to various embodiments of the present disclosure may store instructions to allow the processor 210 to acquire a first acoustic data set corresponding to the first information associated with a speech and/or a second acoustic data set corresponding to the second information associated with the speech, determine similarity between at least some of the first acoustic data set and/or at least some of the second acoustic data set, and generate a super-clustered common acoustic data set associated with at least some of the first acoustic data set and/or at least some of the second acoustic data set based on the determination.

Upon performance, the memory 230 according to various embodiments of the present disclosure may store instructions to allow the processor 210 to decide first parameters corresponding to both of at least some of the first acoustic data set and at least some of the second acoustic data set when the similarity is equal to or more than a selected threshold value, based on the determination, decide a second parameter corresponding to at least some of the first acoustic data set and a third parameter corresponding to at least some of the second acoustic data set when the similarity is less than the threshold value, and generate the super-clustered common acoustic data set based on the first parameters, the second parameter, or the third parameter.

The memory 230 according to various embodiments of the present disclosure may store the super-clustered common acoustic data set, information on at least one decision tree, and at least one acoustic data set indicated by an index of the decision tree.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (e.g., red, green, and blue (RGB) sensor) 240H, a biometric sensor 240I, a temperature/humidity sensor 240J, an illumination (light) sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which may detect an acoustic wave by a microphone (e.g., a microphone 288) of the electronic device 201 through an input means generating an ultrasonic signal to identify data and may perform wireless recognition. According to an embodiment, the electronic device 201 receives a user input from an external device (e.g., computer or server) connected to the electronic device 201 by using the communication module 220.

The display 260 (e.g., display 160) includes a panel 262, a hologram device 264, and a projector 266. The panel 262 may be, for example, a LCD or an active matrix OLED (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 201. According to an embodiment, the display 260 may further include a control circuit for controlling the panel 262, the hologram device 264, and the projector 266.

The interface 270 includes, for example, a HDMI 272, an USB 274, an optical interface 276, and a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC), or an infrared data association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 and the like.

The camera module 291 is a device which may photograph a still image and a video. According to an embodiment, the camera module 291 may include one or more image sensors (e.g., a front sensor or a back sensor), an image signal processor (ISP) (not shown) or a flash (e.g., an LED or xenon lamp).

The power managing module 295 manages power of the electronic device 201. Although not illustrated, the power managing module 295 may include, for example, a power management integrated circuit (PMIC), a charger IC, or a battery or fuel gauge.

The PMIC may be mounted to, for example, an integrated circuit or a SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier and the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., AP 210) of the electronic device 201, for example, a booting status, a message status, a charging status and the like. The motor 298 converts an electrical signal to a mechanical vibration. Although not illustrated, the electronic device 201 may include a processing unit (e.g., GPU) for supporting a mobile TV. The processing unit for supporting the mobile TV may process, for example, media data according to a standard of digital multimedia broadcasting (DMB), digital video broadcasting (DVB), media flow and the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

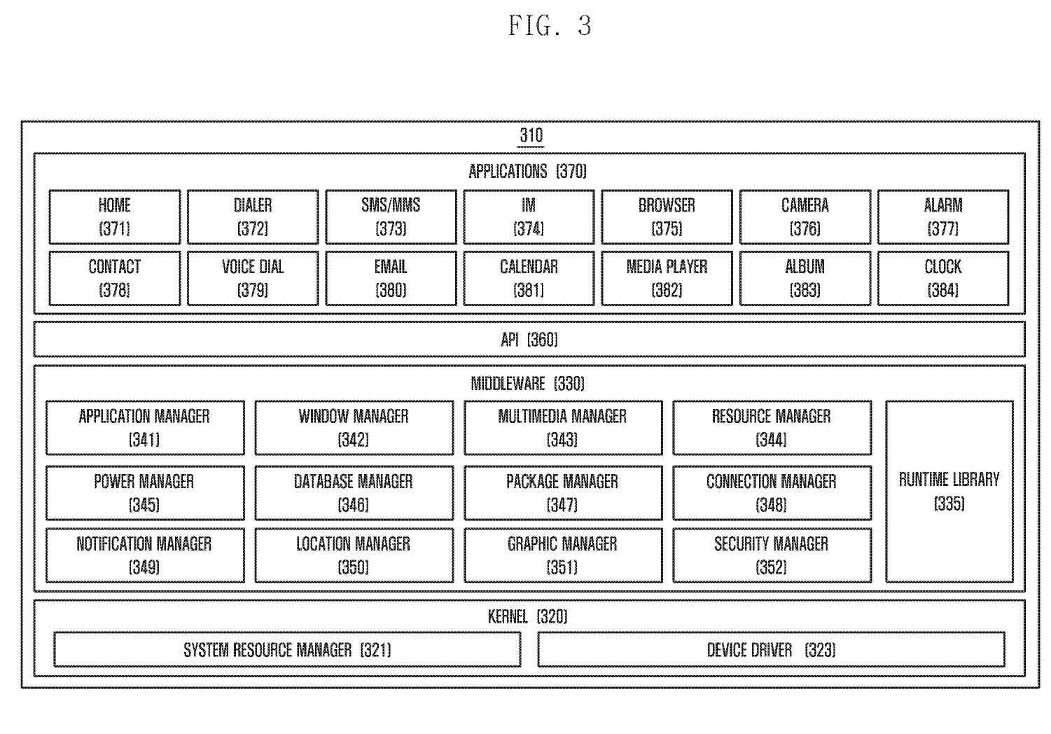

FIG. 3 is a block diagram illustrating a programming module according to an embodiment of the present disclosure.

Referring to FIG. 3, a programming module 310 may be included, e.g. stored, in the electronic apparatus 101, e.g. the memory 130, as illustrated in FIG. 1. At least a part of the programming module 310 (e.g., program 140) may be configured by software, firmware, hardware, and/or combinations of two or more thereof. The programming module 310 may include an OS that is implemented in hardware, e.g., the hardware 200 to control resources related to an electronic device, e.g., the electronic device 101, and/or various applications. e.g., applications 370, driven on the OS. For example, the OS may be Android, iOS, Windows, Symbian, Tizen, Bada, and the like. Referring to FIG. 3, the programming module 310 may include a kernel 320, middleware 330, an API 360, and the applications 370 (e.g., application 147). At least part of the program module 310 may be preloaded on the electronic device or downloaded from a server (e.g., an electronic device 102, 104, server 106, etc.).

The kernel 320, which may be like the kernel 141, may include a system resource manager 321 and/or a device driver 323. The system resource manager 321 may include, for example, a process manager, a memory manager, and a file system manager. The system resource manager 321 may control, allocate, and/or collect system resources. The device driver 323 may include, for example, a display driver, a camera driver, a BT driver, a shared memory driver, a USB driver, a keypad driver, a Wi-Fi driver, and an audio driver. Further, according to an embodiment, the device driver 323 may include an inter-process communication (IPC) driver (not illustrated).

The middleware 330 may include a plurality of modules implemented in advance for providing functions commonly used by the applications 370. Further, the middleware 330 may provide the functions through the API 360 such that the applications 370 may efficiently use restricted system resources within the electronic apparatus. For example, as shown in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352 and a payment manager 354.

The runtime library 335 may include a library module that a compiler uses in order to add a new function through a programming language while one of the applications 370 is being executed. According to an embodiment, the runtime library 335 may perform an input/output, memory management, and/or a function for an arithmetic function.

The application manager 341 may manage a life cycle of at least one of the applications 370. The window manager 342 may manage graphical user interface (GUI) resources used by a screen. The multimedia manager 343 may detect formats used for reproduction of various media files, and may perform encoding and/or decoding of a media file by using a codec suitable for the corresponding format. The resource manager 344 may manage resources such as a source code, a memory, and a storage space of at least one of the applications 370.

The power manager 345 may manage a battery and/or power, while operating together with a basic input/output system (BIOS), and may provide power information used for operation. The database manager 346 may manage generation, search, and/or change of a database to be used by at least one of the applications 370. The package manager 347 may manage installation and/or an update of an application distributed in a form of a package file.

For example, the connectivity manager 348 may manage wireless connectivity such as Wi-Fi or BT. The notification manager 349 may display and/or notify of an event, such as an arrival message, a promise, a proximity notification, and the like, in such a way that does not disturb a user. The location manager 350 may manage location information of an electronic apparatus. The graphic manager 351 may manage a graphic effect which will be provided to a user, and/or a user interface related to the graphic effect. The security manager 352 may provide all security functions used for system security and/or user authentication. According to an embodiment, when an electronic apparatus, e.g., the electronic apparatus 101, has a telephone call function, the middleware 330 may further include a telephony manager (not illustrated) for managing a voice and/or video communication function of the electronic apparatus. The payment manger 354 is capable of relaying payment information from the application 370 to an application 370 or a kernel 320. Alternatively, the payment manager 354 is capable of storing payment-related information received from an external device in the electronic device 200 or transmitting information stored in the electronic device 200 to an external device.

The middleware 330 may generate and use a new middleware module through various functional combinations of the aforementioned internal element modules. The middleware 330 may provide modules specialized according to types of OSs in order to provide differentiated functions. Further, the middleware 330 may dynamically remove some of the existing elements and/or add new elements. Accordingly, the middleware 330 may exclude some of the elements described in the various embodiments of the present disclosure, further include other elements, and/or substitute the elements with elements having a different name and performing a similar function.

The API 360, which may be similar to the API 133, is a set of API programming functions, and may be provided with a different configuration according to the OS. For example, in a case of Android or iOS, one API set may be provided for each of platforms, and in a case of Tizen, two or more API sets may be provided.

The applications 370, which may include an application similar to the application 147, may include, for example, a preloaded application and/or a third party application. The applications 370 may include one or more of the following a home application 371 a dialer application 372, an SMS/multimedia messaging service (MMS) application 373, an instant messaging (IM) application 374, a browser application 375, a camera application 376, an alarm application 377, a contact application 378, a voice dial application 379, an email application 380, a calendar application 381, a media player application 382, an album application 383, a clock application 384, a payment application 385, a health care application (e.g., the measurement of blood pressure, exercise intensity, etc.), an application for providing environment information (e.g., atmospheric pressure, humidity, temperature, etc.), etc. However, the present embodiment is not limited thereto, and the applications 370 may include any other similar and/or suitable application.

According to an embodiment, the applications 370 are capable of including an application for supporting information exchange between an electronic device (e.g., electronic device 101) and an external device (e.g., electronic devices 102 and 104), which is hereafter called ‘information exchange application’). The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, etc.) to external devices (e.g., electronic devices 102 and 104). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 are capable of including an application (e.g., a health care application of a mobile medical device, etc.) specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third party applications that can be downloaded from a server. It should be understood that the components of the program module 310 may be called different names according to types of operating systems.

According to various embodiments, at least part of the program module 310 can be implemented with software, firmware, hardware, or any combination of two or more of them. At least part of the program module 310 can be implemented (e.g., executed) by a processor (e.g., processor 210). At least part of the programing module 310 may include modules, programs, routines, sets of instructions or processes, etc., in order to perform one or more functions.

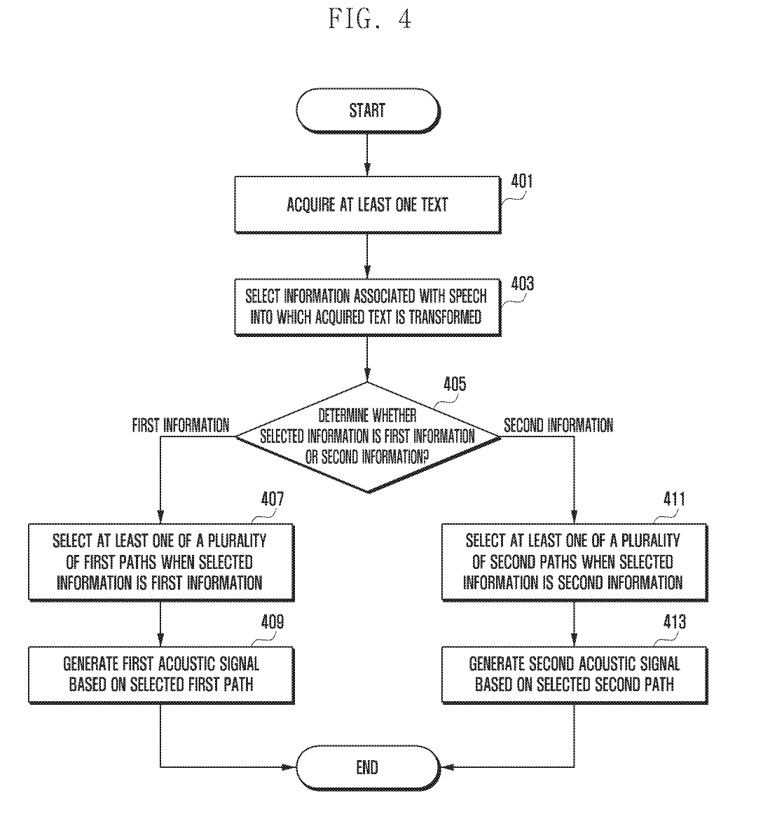

FIG. 4 is a flow chart illustrating an operation of the electronic device 201 according to various embodiments of the present disclosure that selects information associated with a speech into which a text will be transformed and generates an acoustic signal based on the selected information.

Referring to FIG. 4, the electronic device 201 may acquire at least one text in operation 401. The electronic device 201 may acquire at least one text from a user through the input device 250 and receive the text message including at least one text from the external device.

The electronic device 201 may select the information associated with the speech into which the acquired text will be transformed, in operation 403. The information associated with the speech may include language information of the speech or speaker information of the speech. For example, the language information of the speech may include information on what country's language the acoustic data set is composed of, like Korean, English, French, or the like and the speaker information of the speech may include information on what speaker's way of speaking the acoustic data set is composed of, like a male speaker, a female speaker, a speaker by age, a speaker by region (speaker speaking in a dialect), or the like. The electronic device 201 may receive the information associated with the speech from the user to select the information associated with the speech or the electronic device 201 may determine the information associated with the speech by analyzing the acquired text. For example, the electronic device 201 may receive a selection on whether the speech into which the acquired text will be transformed is reproduced into Korean or a male voice from the user or may determine whether the text is composed of a language of any country by analyzing the text. According to various embodiments of the present disclosure, the operation 403 may be selected by the user before the text is acquired, that is, before the operation 401. According to various embodiments of the present disclosure, the selected information may be stored in the memory 230.

The electronic device 201 may check the selected information, in operation 405. The electronic device 201 may determine whether the selected information is the first information or the second information. The electronic device 201 may check the decision tree corresponding to the selected information. The electronic device 201 may receive the data on the decision tree from the external device (for example, super-clustered common acoustic data providing server) and store the received data in the memory 230. The decision tree may be composed of a plurality of paths and end portions (leaf node) of each path may include index information indicating a specific acoustic data of the super-clustered common acoustic data set.

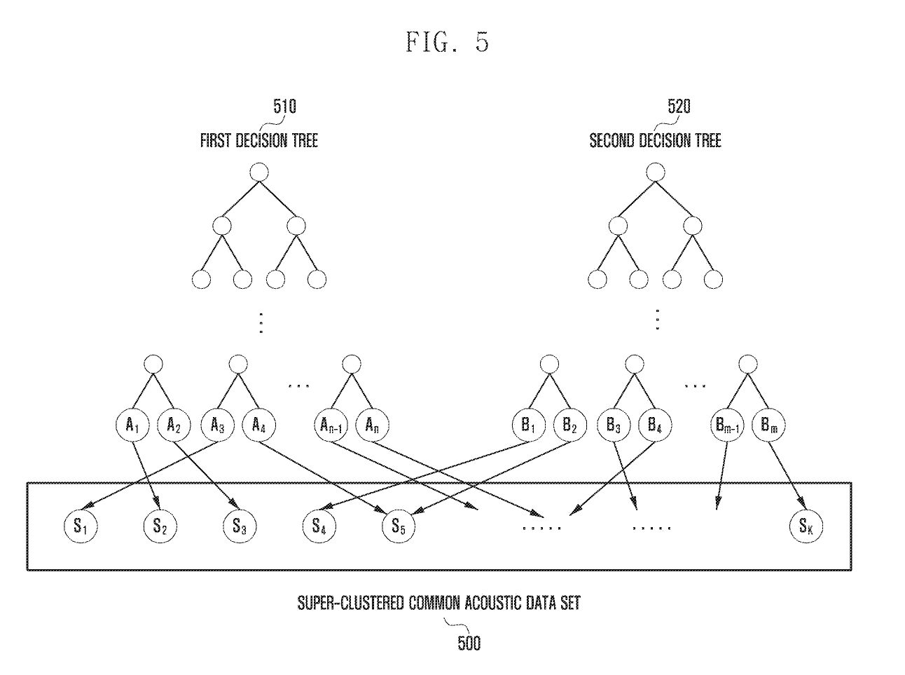

FIG. 5 is a diagram illustrating an operation of the electronic device according to various embodiments of the present disclosure that maps at least one path of an acoustic data set to at least a part of a super-clustered common acoustic data set.

Referring to FIG. 5, a first decision tree 510 may be composed of a plurality of paths indicating a language processing result of English of a female voice and the end portions of each path may include index information indicating acoustic data (for example, acoustic data corresponding to a female voice “g”) in a phoneme unit. According to various embodiments of the present disclosure, the index information included in the decision tree may indicate the acoustic data in the phoneme unit or indicate the acoustic data in the subdivided phoneme unit in which the acoustic data in the phoneme unit is divided into a predetermined time interval

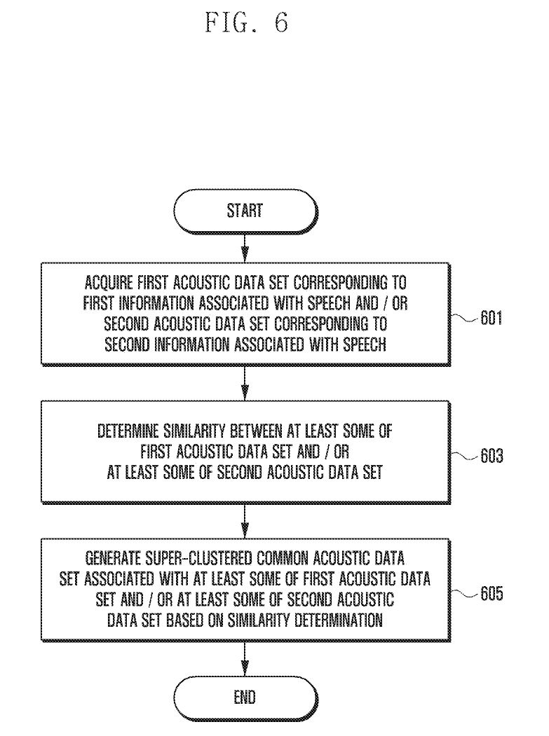

The electronic device 201 may select at least one of a plurality of first paths when the information associated with the speech into which the text will be transformed is the first information, in operation 407. The first information may include at least one of the language information of the speech and the speaker information of the speech. For example, referring to FIG. 5, when the selected information is the English of the female voice, the acquired text is “go”, and the first decision tree 510 corresponding to the selected information is composed of the index information indicating the acoustic data on the English of the female voice, the electronic device 201 may select a path (for example, path up to index A4) on the female voice “g” included in the first decision tree 510 to transform the acquired text into the speech signal and a path (for example, path up to index An-1) on a female voice “o” included in the first decision tree 510. At least one index of the decision tree may indicate at least one acoustic data configuring the super-clustered common acoustic data set. According to various embodiments of the present disclosure, the plurality of first paths may indicate some of the super-clustered common acoustic data set. For example, referring to FIG. 5, one path (path up to index A1) of the first decision tree 510 may indicate an acoustic data S2 of the super-clustered common acoustic data set 500 and another index (path up to index A2) may indicate an acoustic data S3 of the super-clustered common acoustic data set 500. The super-clustered common acoustic data (SCCAD) may be generated based on at least one acoustic data set. The content of the generation of the super-clustered common acoustic data set will be described with reference to the following FIG. 6.

The electronic device 201 may generate the first acoustic signal based on the selected at least one first path in operation 409. The electronic device 201 may load some of the super-clustered common acoustic data set based on the selected at least one first path and generate the first acoustic signal based on the loaded some super-clustered common acoustic data set. Some of the super-clustered common acoustic data set may be a set of acoustic data corresponding to specific speaker information or specific language information of a speech. The electronic data 201 may select at least some of the super-clustered common acoustic data set based on the input text and generate the first acoustic signal additionally based on at least some of some of the super-clustered common acoustic data set. At least some of some of the super-clustered common acoustic data set represents the acoustic data corresponding to elements of the acoustic signal and may correspond to at least one of spectrum, pitch, and noise of at least some of the acoustic signals. For example, referring to FIG. 5, to transform “go” that is a text acquired by the electronic device 201 into the acoustic signal, the electronic device 201 may select the path (path up to index A4) for “g” included in the first decision tree 510 and the path (path up to index An-1) for “o” included in the first decision tree 510 and may select at least one acoustic data (acoustic data indicated by the selected index) corresponding to the selected at least one first path from the super-clustered common acoustic data set. The electronic device 201 may load the selected at least one acoustic data of the super-clustered common acoustic data set and generate the first acoustic signal based on the loaded acoustic data. The electronic device 201 may output the first acoustic signal through the speaker 282. The electronic device 201 according to various embodiments of the present disclosure may analyze the input text sentence in the phoneme unit or analyze the subdivided phoneme unit in which the phoneme is divided. The electronic device 201 may select the acoustic data for each phoneme unit or each subdivided phoneme unit and synthesize the selected acoustic data to generate a synthesized sound for the entire text. The electronic device 201 may output the synthesized sound for the entire text through the speaker 282.

The electronic device 201 may select at least one of a plurality of second paths when the information associated with the speech into which the text will be transformed is the second information, in operation 411. The second information is information different from the first information and may include at least one of the language information of the speech and the speaker information of the speech. For example, referring to FIG. 5, when the selected information is information on Korean of a male voice and the second decision tree 520 corresponding to the selected information is present, at least one index of the decision tree may indicate at least acoustic data configuring the super-clustered common acoustic data set. According to various embodiments of the present disclosure, the plurality of second paths may indicate some of the super-clustered common acoustic data set. For example, referring to FIG. 5, one path (path up to index B1) of the second decision tree 520 may indicate an acoustic data S4 of the super-clustered common acoustic data set 500 and another index (path up to index B2) may indicate an acoustic data S5 of the super-clustered common acoustic data set 500.

The electronic device 201 may generate the second acoustic signal based on the selected at least one second path in operation 413. The electronic device 201 may load some (acoustic data loaded based on the first path in operation 409) or another some of the super-clustered common acoustic data set based on the selected at least one second path and generate the second acoustic signal based on the loaded some or another some super-clustered common acoustic data set. For example, referring to FIG. 5, one path (path up to index A4) of the first decision tree 510 and one path (path up to index B2) of the second decision tree 520 may indicate the same acoustic data S5. Some or another some of the super-clustered common acoustic data set may be a set of acoustic data corresponding to specific speaker information or specific language information of a speech. The electronic data 201 may select at least some of the super-clustered common acoustic data set based on the input text and generate the second acoustic signal additionally based on at least some of some of the super-clustered common acoustic data set. At least some of some of the super-clustered common acoustic data set represents the acoustic data corresponding to elements of the acoustic signal and may correspond to at least one of spectrum, pitch, and noise of at least some of the acoustic signals. The electronic device 201 may load the selected at least one acoustic data of the super-clustered common acoustic data set and generate the second acoustic signal based on the loaded acoustic data. The electronic device 201 may output the second acoustic signal through the speaker 282. The electronic device 201 according to various embodiments of the present disclosure may analyze the input text sentence in the phoneme unit or analyze the subdivided phoneme unit in which the phoneme is divided. The electronic device 201 may select the acoustic data for each phoneme unit or each subdivided phoneme unit and synthesize the selected acoustic data to generate a synthesized sound for the entire text. The electronic device 201 may output the synthesized sound for the entire text through the speaker 282.

FIG. 6 is a flow chart illustrating an operation of the electronic device 201 according to various embodiments of the present disclosure that generates the super-clustered common acoustic data.

The electronic device 201 may acquire the first acoustic data set corresponding to the first information associated with the speech and the second acoustic data set corresponding to the second information associated with the speech. The first information or the second information may include the language information or the speaker information of the speech.

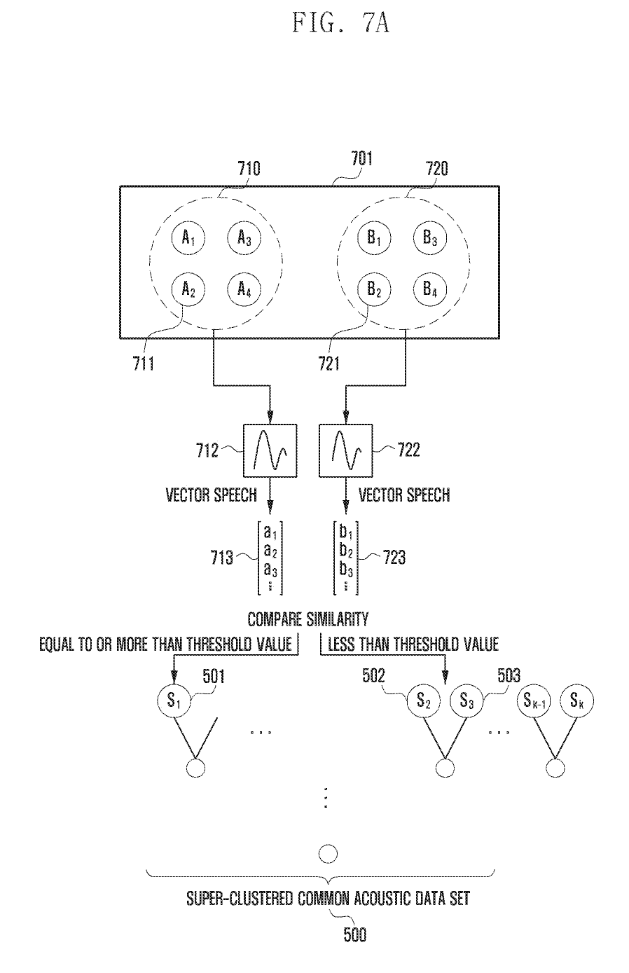

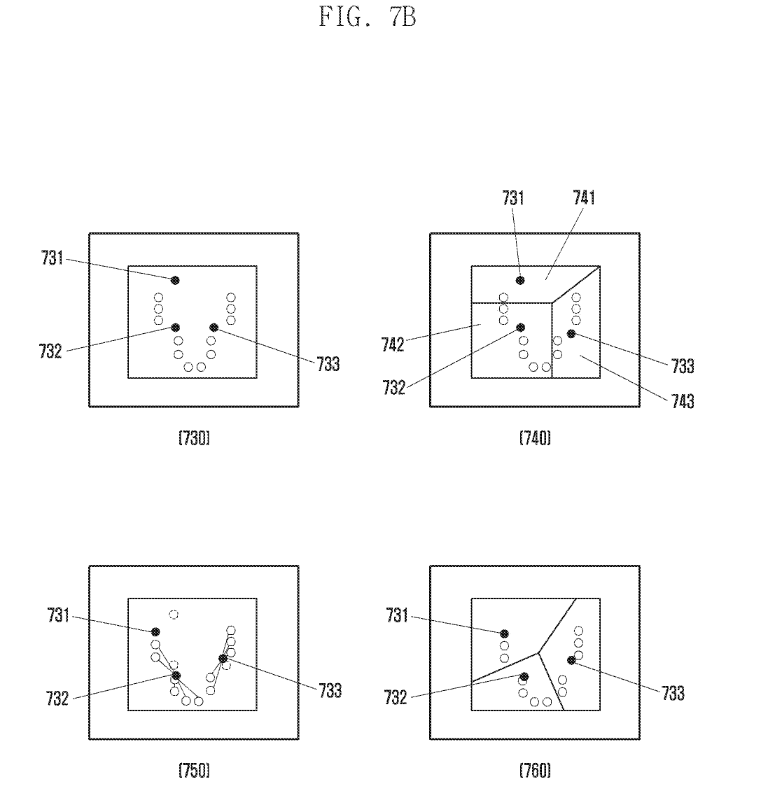

FIG. 7A is a diagram illustrating an operation of the electronic device according to various embodiments of the present disclosure that determines similarity between at least a part of a first acoustic data set and at least a part of a second acoustic data set and generates the super-clustered common acoustic data set based on the determination on the similarity.

Referring to FIG. 7A, the electronic device 201 may acquire a first acoustic data set 710 that is a set of the acoustic data corresponding to the English of the female voice (first information) and a second acoustic data set 720 that is a set of the acoustic data corresponding to the Korean of the male voice (second information).

A method for configuring super-clustered common acoustic data as a first acoustic data set and a second acoustic data set in operation 601 will be described but the acoustic data set more than that may be acquired. The plurality of acoustic data set may be acquired and processes under operation 603 may be performed on the plurality of acoustic data set.

The electronic device 201 may determine the similarity between at least some of the first acoustic data set and/or at least some of the second acoustic data set in the operation 603. The electronic device 201 may determine at least one similarity of spectrum, pitch, and noise of at least some of the acoustic data set. For example, the electronic device 201 may vector the acoustic data corresponding to at least some of the acoustic data set based on vector quantization to determine the similarity. The electronic device 201 may vector at least one of the spectrum, the pitch, and the noise of the acoustic signal and determine the similarity based on the vectored value. For example, referring to FIG. 7A, the electronic device 201 may acquire the entire acoustic data set 701 collecting at least some of the first acoustic data set 710 and/or at least one of the second acoustic data set 720. The electronic device 201 may determine similarity between an acoustic data A2 711 of the entire acoustic data set 701 and an acoustic data B2 721 of the entire acoustic data set 701. To determine the similarity, the electronic device 201 may vector spectrum 712 of the acoustic data A2 711 to acquire a vector value 713 and vector spectrum 722 of the acoustic data B2 721 to acquire a vector value 723. The electronic device 201 may compare a speech vector value 521 of the A2 with a speech vector value 522 of the B3 to determine the similarity between the acoustic data. The electronic device 201 according to various embodiments of the present disclosure may perform K-means algorithm, Fuzzy algorithm, Gaussian mixture model (GMM) algorithm, Lloyd algorithm, or the like to determine the similarity between at least some of the first acoustic data set and/or at least some of the second acoustic data set. The electronic device 201 according to various embodiments of the present disclosure may acquire the entire acoustic data set 701 collecting at least some of the first acoustic data set 710 and the second acoustic data set 720, (1) determines the similarity between the acoustic data of the first acoustic data set 710 of the entire acoustic data set 701 and the acoustic data of the second acoustic data set 720 thereof, (2) determines the similarity between the acoustic data of the first acoustic data set 710 of the entire acoustic data set 701, or (3) determine the similarity between the acoustic data of the second acoustic data set 720 of the entire acoustic data set 701.

The electronic device 201 according to various embodiments of the present disclosure may acquire the entire acoustic data set collecting at least one acoustic data set and divide the entire acoustic data set into a predetermined number of clusters including a plurality of acoustic data.

FIG. 7B is a diagram illustrating an operation of the electronic device according to various embodiments of the present disclosure that performs a clustering algorithm in the entire acoustic data set collecting at least one acoustic data set.

Referring to <730> of FIG. 7B, the electronic device 201 may randomly select representative acoustic data 731, 732, and 733 from the entire acoustic data set 710 collecting at least one acoustic data set. Referring to <740>, the electronic device 201 may divide clusters 741, 742, and 743 based on an average distance of the representative acoustic data 731, 732, and 733 for each acoustic data. Referring to <750>, the electronic device 201 may determine similarity between the respective acoustic data and the representative acoustic data 731, 732, and 733 to divide the respective acoustic data as the representative acoustic data having high similarity. Referring to <760>, the electronic device 201 may readjust the clusters based on the divided acoustic data. The electronic device 201 may perform clustering algorithm repeating the processes <730> to <760> to form a cluster of an acoustic data having high similarity. The electronic device 201 may generate the super-clustered common acoustic data set associated with some of the first acoustic data set and at least some of the second acoustic data set based on the similarity determination in operation 605. The electronic device 201 may decide the first parameters corresponding to both of at least some of the first acoustic data set and at least some of the second acoustic data set when the similarity is equal to or more than the selected threshold value and decide the second parameter corresponding to at least some of the first acoustic data set and the third parameter corresponding to at least some of the second acoustic data set when the similarity is less than the threshold value. The first parameters, the second parameter, or the third parameter may correspond to at least one of the spectrum, the pitch, and the noise of at least some of the speech. For example, referring to FIG. 7A, when the similarity between the spectrum 712 of the acoustic data A2 711 of the entire acoustic data set 701 and the spectrum 722 of the acoustic data B2 721 of the entire acoustic data set 720 is equal to or more than the threshold value, the electronic device 201 may generate spectrum of an acoustic data S1 530a corresponding to both of the spectrum 712 of the acoustic data A2 711 and the spectrum 722 of the acoustic data B2 721. When the similarity between the spectrum 712 of the acoustic data A2 711 of the entire acoustic data set 701 and the spectrum 722 of the acoustic data B2 721 of the entire acoustic data set 720 is equal to or more than the threshold value, the electronic device 201 according to various embodiments of the present disclosure may decide one of the spectrum 712 of the acoustic data A2 711 and the spectrum 722 of the acoustic data B2 721 as the acoustic data S1 501 of the super-clustered common acoustic data set 500.

The electronic device 201 according to various embodiments of the present disclosure may generate the spectrum of the acoustic data S2 502 corresponding to the spectrum of the acoustic data A2 711 and the spectrum of the acoustic data S3 503 corresponding to the spectrum of the acoustic data B2 721, when the similarity between the spectrum of the acoustic data A2 711 of the entire acoustic data set 701 and the spectrum of the acoustic data B2 721 of the entire acoustic data set 701 is less than the threshold value. The electronic device 201 according to various embodiments of the present disclosure may decide the spectrum of the acoustic data A2 711 as the spectrum of the acoustic data S2 502 and decide the spectrum of the acoustic data B2 721 as the spectrum of the acoustic data S3 503, when the similarity between the spectrum of the acoustic data A2 711 of the entire acoustic data set 701 and the spectrum of the acoustic data B2 721 of the entire acoustic data set 701 is less than the threshold value. The electronic device 201 according to various embodiments of the present disclosure may set the threshold value enough not to cause the reduction in sound quality between the acoustic data of the super-clustered common acoustic data set and cluster the acoustic data of the super-clustered data set based on the threshold value. The electronic device 201 may perform the K-means algorithm, the Fuzzy algorithm, the GMM algorithm, the Lloyd algorithm, or the like to determine the acoustic data having similarity that is equal to or more than the threshold value and decide the super-clustered common acoustic data representing the acoustic data. The electronic device 201 may determine the acoustic data having similarity less than the threshold value and decide the super-clustered common acoustic data corresponding to the respective acoustic data.

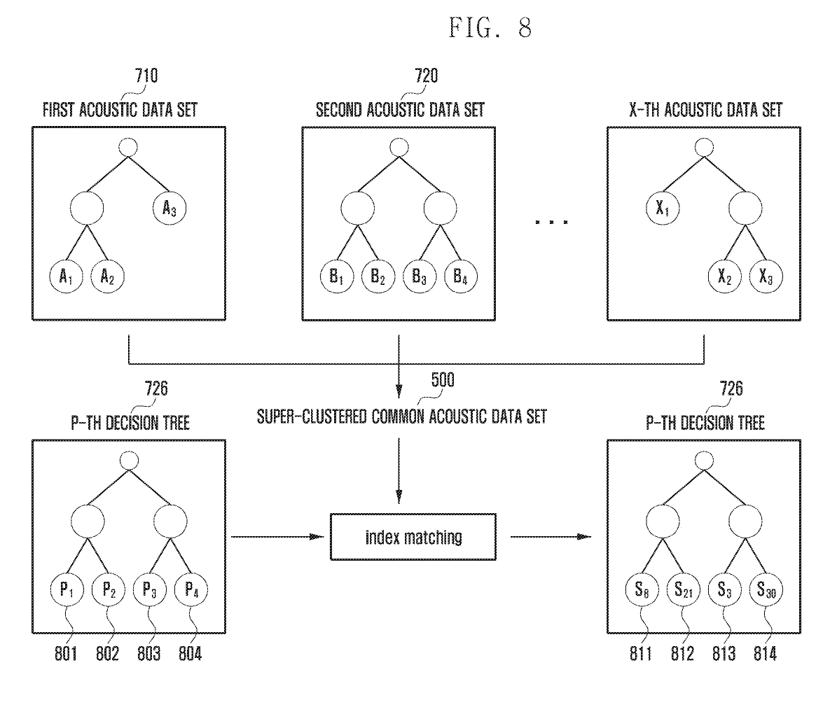

FIG. 8 is a diagram illustrating an operation of the electronic device 201 according to various embodiments of the present disclosure that generates the super-clustered common acoustic data set and matches a plurality of paths of a specific acoustic data to the super-clustered common acoustic data set.

Referring to FIG. 8, the electronic device 201 may generate the super-clustered common acoustic data (SCCAD) 500 using at least one acoustic data set. The electronic device 201 may determine the similarity between the acoustic data of the entire acoustic data set collecting the respective acoustic data sets. The determination on the similarity between the acoustic data may be performed by comparing at least one of the spectrum, the pitch, the noise, or the like of the speech. When the similarity between the acoustic data is equal to or more than the selected threshold value, the electronic device 201 may decide parameters corresponding to all the acoustic data and when the similarity therebetween is less than the threshold value, the electronic device 201 may decide the parameters corresponding to the respective acoustic data. For example, referring to FIG. 7A, the electronic device 201 may determine the similarity between the acoustic data A3 of the entire acoustic data set 701 and the acoustic data B2 of the entire acoustic data set 701 to decide the first parameters corresponding to both of the acoustic data A3 and the acoustic data B2 if the similarity is equal to or more than the threshold value and decide the second parameter corresponding to the acoustic data A3 and the third parameter corresponding to the acoustic data B2 if the similarity is less than the threshold value. The electronic device 201 may generate the acoustic data of the super-clustered common acoustic data set 500 based on the first parameters, the second parameter, or the third parameter.

The electronic device 201 may additionally acquire a new acoustic model in addition to the existing acoustic model and the newly acquired acoustic model may include a decision tree and the acoustic data set matched with the decision tree. When acquiring the new acoustic model, the electronic device 201 may newly match the decision tree of the acoustic model with the super-clustered common acoustic data set. For example, referring to FIG. 8, the electronic device 201 may acquire a P acoustic model including a P decision tree 726 and a P acoustic data and the electronic device 201 may check acoustic data of a P acoustic data set indicated by an index P1 801 of the P decision tree 726 when the P decision tree 726 is composed of a plurality of paths (paths up to indexes P1, P2, P3, and P4). The electronic device 201 may search for the acoustic data having the highest similarity to the acoustic data originally indicated by the P1 801 in the super-clustered common acoustic data set 500 and replace the index P1 801 of the P decision tree 726 by an index S8 811 indicating the acoustic data of the common acoustic data. Similarly, the electronic device 201 may replace the index P2 802 of the P decision tree 726 by an index S21 812 indicating the acoustic data of the super-clustered common acoustic data, replace the index P3 803 of the P decision tree 726 by an index S3 813 indicating the acoustic data of the super-clustered common acoustic data, and replace the index P4 804 of the P decision tree 726 by an index S30 814 indicating the acoustic data of the super-clustered common acoustic data. Each of the indexes of the P decision tree 726 may be replaced by indexes that indicate the acoustic data (acoustic data of the super-clustered common acoustic data set) having the highest similarity to the acoustic data originally indicated.

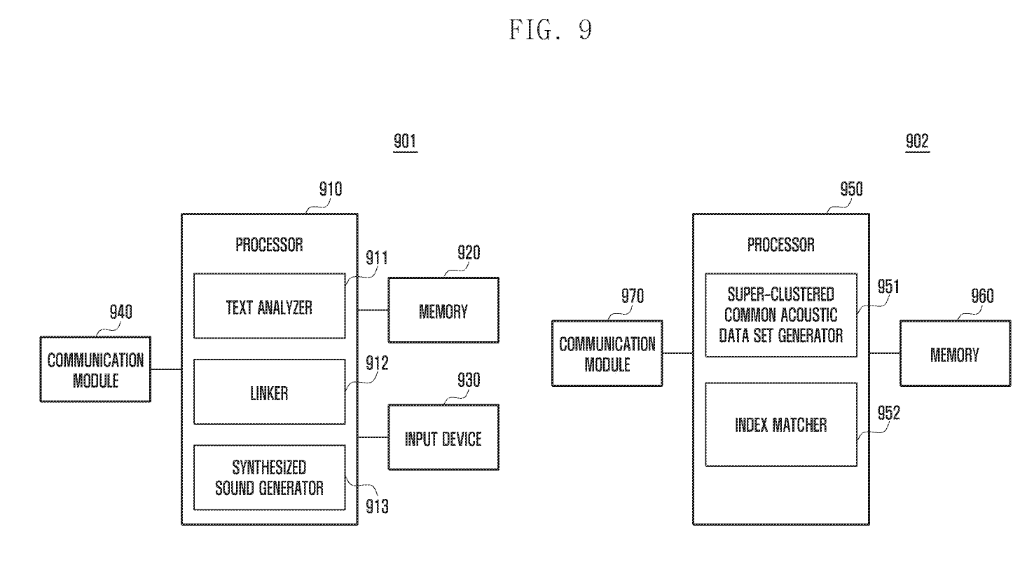

FIG. 9 is a block diagram of a first electronic device and a block diagram of a second electronic device according to various embodiments of the present disclosure.

Referring to FIG. 9, a first electronic device 901 may include a processor 910, a memory 920, an input device 930, and a communication module 940. A second electronic device 902 may include a processor 950, a memory 960, and a communication module 970. Although not illustrated in FIG. 9, the first electronic device 901 and the second electronic device 902 according to various embodiments of the present disclosure may include all the components of the electronic device 201 illustrated in FIG. 2.

The processor 910 of the first electronic device 901 according to various embodiments of the present disclosure may perform a function of the processor 210 of the electronic device 201 of FIG. 2. The processor 910 may include a text analyzer 911, a linker 912, and a synthesized sound generator 913.

The text analyzer 911 may analyze at least one text acquired by the electronic device 901 and may select the information associated with the speech that the acquired text will be transformed. For example, the text analyzer 911 may analyze the text to select information on whether the text is reproduced as Korean or male voice.

The linker 912 may determine whether the selected information is the first information or the second information. The linker 912 may check the decision tree corresponding to the selected information. The linker 912 may select at least one of the plurality of first paths included in the decision tree when the information associated with the speech into which the text will be transformed is the first information. The linker 912 may load some of the super-clustered common acoustic data set based on the selected at least one first path. The linker 912 may select at least one of the plurality of second paths included in the decision tree when the information associated with the speech into which the text will be transformed is the second information. The linker 912 may load some or another some of the super-clustered common acoustic data set based on the selected at least one second path. The synthesized sound generator 913 may generate the first acoustic signal based on the selected at least one first path. The synthesized sound generator 913 may select at least some of the super-clustered common acoustic data set based on the input text and generate the first acoustic signal additionally based on at least some of some of the super-clustered common acoustic data set. The synthesized sound generator 913 may output the first acoustic signal through the speaker 282. The synthesized sound generator 913 may load the plurality of super-clustered common acoustic data based on the plurality of first paths selected by the linker 912 and synthesize the acoustic data loaded to output a speech in a sentence unit and then output the synthesized acoustic data.

The synthesized sound generator 913 may generate the second acoustic signal based on the selected at least one second path. The synthesized sound generator 913 may select at least some of the super-clustered common acoustic data set based on the input text and generate the second acoustic signal additionally based on at least some of some of the super-clustered common acoustic data set. The synthesized sound generator 913 may output the second acoustic signal through the speaker 282. The synthesized sound generator 913 may load the plurality of super-clustered common acoustic data based on the plurality of second paths selected by the linker 912 and synthesize the acoustic data loaded to output the speech in the sentence unit and then output the synthesized acoustic data.

Upon performance, the memory 920 of the electronic device 901 according to various embodiments of the present disclosure may store instructions to allow the processor 910 to acquire at least one text, select the information associated with a speech into which the acquired text will be transformed, when the selected information is the first information, select at least one of the plurality of first paths, load some of the super-clustered common acoustic data set based on the selected at least one first path, and generate the first acoustic signal based on the loaded some super-clustered common acoustic data set, and when the selected information is second information, select at least one of the plurality of second paths, load some or another some of the super-clustered common acoustic data set based on the selected at least one second path, and generate the second acoustic signal based on the loaded some or another some super-clustered common acoustic data set.

Upon performance, the memory 920 according to various embodiments of the present disclosure may store instructions to allow the processor 910 to acquire the at least one text from a user or receive the text message including the at least one text from an external device.

Upon performance, the memory 920 according to various embodiments of the present disclosure may store instructions to allow the processor 910 to select at least some of some of the super-clustered common acoustic data set based on the input text and generate the first acoustic signal or the second acoustic signal additionally based on at least some of some of the super-clustered common acoustic data set.

The memory 920 according to various embodiments of the present disclosure may store the information on the super-clustered common acoustic data set and at least one decision tree.

The input device 930 of the first electronic device 930 according to various embodiments of the present disclosure may perform the function of the input device 250 of the electronic device 201 of FIG. 2. The input device 250 may acquire at least one text to be transformed into the speech from user.

The communication module 940 of the first electronic device 901 according to various embodiments of the present disclosure may perform the function of the communication module 220 of the electronic device 201 of FIG. 2. The communication module 940 may transmit a request message requesting the information on the decision tree and/or the information on the super-clustered common acoustic data set to the second electronic device 902 and receive the information on the decision tree and/or the super-clustered common acoustic data set from the second electronic device 902.

The second electronic device 902 according to various embodiments of the present disclosure may generate the super-clustered common acoustic data set and serve as a server providing the super-clustered common acoustic data set.

The processor 950 of the second electronic device 902 according to various embodiments of the present disclosure may perform a function of the processor 210 of the electronic device 201 of FIG. 2. The processor 950 may include a super-clustered common acoustic data set generator 951 and an index matcher 952.

The super-clustered common acoustic data set generator 951 according to various embodiments of the present disclosure may acquire the first acoustic data set corresponding to the first information associated with the speech and the second acoustic data set corresponding to the second information associated with the speech. The super-clustered common acoustic data set generator 951 may perform the following operations by acquiring the plurality of acoustic data sets in addition to the first acoustic data set and the second acoustic data set. The super-clustered common acoustic data set generator 951 may determine the similarity between at least some of the first acoustic data set and/or at least some of the second acoustic data set in the operation 603. The super-clustered common acoustic data set generator 951 may generate the super-clustered common acoustic data set associated with some of the first acoustic data set and at least some of the second acoustic data set based on the similarity determination in operation 605. The super-clustered common acoustic data set generator 951 may decide the first parameters corresponding to both of at least some of the first acoustic data set and at least some of the second acoustic data set when the similarity is equal to or more than the selected threshold value and decide the second parameter corresponding to at least some of the first acoustic data set and the third parameter corresponding to at least some of the second acoustic data set when the similarity is less than the threshold value. The first parameters, the second parameter, or the third parameter may correspond to at least one of the spectrum, the pitch, and the noise of at least some of the speech.

When acquiring the new acoustic model, the index matcher 952 according to various embodiments of the present disclosure may newly match the decision tree of the acoustic model with the super-clustered common acoustic data set. The newly acquired acoustic model may include the decision tree and the acoustic data set indicated by the decision tree. The index matcher 952 may determine the similarity between the acoustic data set included in the newly acquired acoustic model and the super-clustered common acoustic data set and may replace the index to allow the decision tree of the newly acquired acoustic model to indicate the data (data having the highest similarity to the newly acquired acoustic data set) of the super-clustered common acoustic data set.

The memory 960 of the second electronic device 902 according to various embodiments of the present disclosure may perform the function of the memory 230 of the electronic device 201 of FIG. 2. Upon performance, the memory 960 may store instructions to allow the processor 950 to acquire the first acoustic data set corresponding to the first information associated with a speech and/or the second acoustic data set corresponding to the second information associated with the speech, determine the similarity between at least some of the first acoustic data set and/or at least some of the second acoustic data set, and generate the super-clustered common acoustic data set associated with at least some of the first acoustic data set and/or at least some of the second acoustic data set based on the determination.

Upon performance, the memory 960 according to various embodiments of the present disclosure may store instructions to allow the processor 950 to decide, based on the determination, the first parameters corresponding to both of at least some of the first acoustic data set and at least some of the second acoustic data set when the similarity is equal to or more than a selected threshold value and decide the second parameter corresponding to at least some of the first acoustic data set and the third parameter corresponding to at least some of the second acoustic data set when the similarity is less than the threshold value, and generate the super-clustered common acoustic data set based on the first parameters, the second parameter, or the third parameter.

The memory 960 according to various embodiments of the present disclosure may store the super-clustered common acoustic data set, the information on at least one decision tree, and at least one acoustic data set indicated by the index of the decision tree.

The input device 970 of the second electronic device 902 according to various embodiments of the present disclosure may perform the function of the communication module 220 of the electronic device 201 of FIG. 2. The communication module 940 may receive the request message requesting the information on the decision tree and/or the information on the super-clustered common acoustic data set from the first electronic device 901 and transmit the information on the decision tree and/or the super-clustered common acoustic data set to the first electronic device 901.

In the present disclosure, the terminology ‘module’ refers to a ‘unit’ including hardware, software, firmware or a combination thereof. For example, the terminology ‘module’ is interchangeable with ‘unit,’ logic, ‘logical block,’ ‘component,’ ‘circuit,’ or the like. A ‘module’ may be the smallest unit or a part of an integrated component. A ‘module’ may be the smallest unit or a part thereof that can perform one or more functions. A ‘module’ may be implemented in mechanical or electronic mode. For example, a ‘module’ may include at least one of the following an application specific integrated circuit (ASIC) chip, field-programmable gate array (FPGAs) and a programmable-logic device that can perform functions that are known or will be developed.

At least part of the method (e.g., operations) or devices (e.g., modules or functions) according to various embodiments may be implemented with instructions that can be conducted via various types of computers and stored in computer-readable storage media, as types of programming modules, for example. One or more processors (e.g., processor 120) can execute command instructions, thereby performing the functions. An example of the computer-readable storage media may be memory 130.

Examples of computer-readable media include magnetic media, such as hard disks, floppy disks, and magnetic tape; optical media such as compact disc read only memory (CD-ROM) disks and DVD; magneto-optical media, such as floptical disks; and hardware devices such as ROM, random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules to perform the operations of various embodiments described above, or vice versa.

Modules or programming modules according to various embodiments may include one or more components, remove part of them described above, or further include new components. The operations performed by modules, programming modules, or other components, according to various embodiments, may be executed in serial, parallel, repetitive or heuristic fashion. Part of the operations can be executed in any other order, skipped, or executed with additional operations.

While the present disclosure has been shown and described with reference to various embodiments thereof, it will be understood by those skilled in the art that various changes in form and details may be made therein without departing from the spirit and scope of the present disclosure as defined in the appended claims and their equivalents.

What is claimed is:

1. An electronic device comprising:
a processor; and
a memory electrically connected to the processor,
wherein the memory is configured to store a super-clustered common acoustic data set, and
wherein, the memory is further configured to store instructions to allow the processor to:
acquire at least one text,
select information associated with a speech into which the acquired text is transformed,
when the selected information is first information, select at least one of a plurality of first paths, load at least one element of the super-clustered common acoustic data set based on the selected at least one first path, and generate a first acoustic signal based on the loaded at least one element of the super-clustered common acoustic data set, and
when the selected information is second information, select at least one of a plurality of second paths, load at least one element or at least one other element of the super-clustered common acoustic data set based on the selected at least one second path, and generate a second acoustic signal based on the loaded at least one element or at least one other element of super-clustered common acoustic data set.

2. The electronic device of claim 1, wherein the information associated with the speech includes language information and/or speaker information of the speech.

3. The electronic device of claim 1, wherein the instructions allow the processor to acquire the at least one text from a user or receive a text message including the at least one text from an external device.

4. The electronic device of claim 1, wherein the instructions allow the processor to:
select at least one element of the at least one element of the super-clustered common acoustic data set based on the input text, and
generate the first acoustic signal or the second acoustic signal additionally based on the at least one element of the at least one element of the super-clustered common acoustic data set.

5. The electronic device of claim 4, wherein the at least one element of the at least one element of the super-clustered common acoustic data set corresponds to at least one of spectrum, pitch, or noise of at least a portion of the generated acoustic signal.

6. The electronic device of claim 1, wherein the plurality of first paths or the plurality of second paths indicate the at least one element of the super-clustered common acoustic data set.

7. An electronic device comprising:
a processor; and
a memory electrically connected to the processor,
wherein the memory is configured to store instructions to allow the processor to:
acquire a first acoustic data set corresponding to the first information associated with the speech and a second acoustic data set corresponding to the second information associated with the speech,
determine a similarity between at least one element of the first acoustic data set and/or at least one element of the second acoustic data set, and
generate a super-clustered common acoustic data set associated with the at least one element of the first acoustic data set and/or the at least one element of the second acoustic data set based on the determination.

8. The electronic device of claim 7, wherein the first information or the second information includes language information and/or speaker information of the speech.

9. The electronic device of claim 7, wherein the instructions allow the processor to:
decide first parameters corresponding to both of the at least one element of the first acoustic data set and the at least one element of the second acoustic data set when the similarity is equal to or more than a selected threshold value, based on the determination,
decide a second parameter corresponding to the at least one element of the first acoustic data set and a third parameter corresponding to the at least one element of the second acoustic data set when the similarity is less than the threshold value, and
generate the super-clustered common acoustic data set based on the first parameters, the second parameter, or the third parameter.

10. The electronic device of claim 9, wherein the first parameters, the second parameter, or the third parameter corresponds to at least one of spectrum, pitch, or noise of at least some of the speech.

11. A method for transforming text to speech (TTS) of an electronic device, the method comprising:
acquiring at least one text,
selecting information associated with a speech into which the acquired text is transformed,
when the selected information is first information, selecting at least one of a plurality of first paths, loading at least one element of the super-clustered common acoustic data set based on the selected at least one first path, and generating a first acoustic signal based on the loaded at least one element of the super-clustered common acoustic data set, and
when the selected information is second information, selecting at least one of the plurality of second paths, loading at least one element or at least one other element of the super-clustered common acoustic data set based on the selected at least one second path, and generating a second acoustic signal based on the loaded at least one element or at least one other element of super-clustered common acoustic data set.

12. The method of claim 11, wherein the information associated with the speech includes language information and/or speaker information of the speech.

13. The method of claim 11, wherein the acquiring of the text includes acquiring the at least one text from a user or receiving a text message including the at least one text from an external device.

14. The method of claim 11, wherein the generating of the first acoustic signal or the second acoustic signal includes:
selecting at least one element of the at least one element of the super-clustered common acoustic data set based on the input text; and
generating the first acoustic signal or the second acoustic signal additionally based on the at least one element of the at least one element of the super-clustered common acoustic data set.

15. The method of claim 14, wherein the at least one element of the at least one element of the super-clustered common acoustic data set corresponds to at least one of spectrum, pitch, or noise of at least a portion of the generated acoustic signal.

16. The method of claim 11, wherein the plurality of first paths or the plurality of second paths indicate the at least one element of the super-clustered common acoustic data set.

17. A method for transforming text to speech (TTS) of an electronic device, the method comprising:
acquiring a first acoustic data set corresponding to first information associated with a speech into which at least one text is transformed and/or a second acoustic data set corresponding to second information associated with the speech;
determining a similarity between at least one element of the first acoustic data set and/or at least one element of the second acoustic data set; and
generating a super-clustered common acoustic data set associated with the at least one element of the first acoustic data set and/or the at least one element of the second acoustic data set based on the determination.

18. The method of claim 17, wherein the first information or the second information includes language information and/or speaker information of the speech.

19. The method of claim 17, wherein the generating of the super-clustered common acoustic data set includes:
deciding first parameters corresponding to both of the at least one element of the first acoustic data set and the at least one element of the second acoustic data set when the similarity is equal to or more than a selected threshold value, based on the determination;
deciding a second parameter corresponding to the at least one element of the first acoustic data set and a third parameter corresponding to the at least one element of the second acoustic data set when the similarity is less than the threshold value; and
generating the super-clustered common acoustic data set based on the first parameters, the second parameter, or the third parameter.

20. The method of claim 19, wherein the first parameters, the second parameter, or the third parameter corresponds to at least one of spectrum, pitch, or noise of at least a portion of the speech.
